(19) United States
(12) Patent Application Publication
(10) Pub. No.: US 2021/0215952 A1
(43) Pub. Date: Jul. 15, 2021

(54) TEMPLE-BENDING STRUCTURE AND SMART GLASSES INCLUDING THE SAME

(71) Applicant: YUTOU TECHNOLOGY (HANGZHOU) CO., LTD., Hangzhou (CN)

(72) Inventors: Songbo FANG, Hangzhou (CN); Qingyang SHEN, Hangzhou (CN); Wengang WANG, Hangzhou (CN)

(21) Appl. No.: 17/144,616

(22) Filed: Jan. 8, 2021

(30) Foreign Application Priority Data
Jan. 10, 2020 (CN) 202020051670.7

(51) Int. Cl. G02C 5/22

(52) U.S. Cl. CPC G02C 5/22

(57) ABSTRACT

The present application relates to a temple-bending structure and smart glasses including the temple-bending structure. The temple-bending structure includes a rotating shaft structure. One end of the rotating shaft structure is connected to a lens body, and the other end of the rotating shaft structure is connected to a temple. A flexible printed circuit (FPC) penetrates through the rotating shaft structure from the inside of the temple and is connected to a main board inside the lens body. The rotating shaft structure is rotated to control the temple to bend relative to the lens body. The rotating shaft structure includes a rotating shaft housing. One end of the rotating shaft housing is fixed to the temple, and the other end of the rotating shaft housing extends to the inside of the lens body. The rotating shaft housing rotates with the temple.

### PRIORITY APPLICATION

This application claims the benefit of and priority to CN Patent Application No. 202020051670.7, filed Jan. 10, 2020, the entire contents of which are incorporated herein by reference.

### TECHNICAL FIELD

The present application relates to the field of smart glasses technologies, and in particular, to a temple-bending structure and smart glasses including the same.

### BACKGROUND

In smart glasses such as AR and MR glasses, a circuit signal needs to be conducted from a signal input interface on a temple to a main board on a lens body through a flexible printed circuit (FPC). If the smart glasses adopt a bending structure used for a temple of myopia glasses in the prior art, the FPC is exposed and is easily damaged when the glasses are folded.

In existing smart glasses, a lens body and a temple are fixed to avoid exposing an FPC and protect the FPC. However, this structure makes the smart glasses large in volume and inconvenient to carry or store. Therefore, how to provide a temple-bending structure that can protect the FPC and implement portability is a technical problem to be urgently solved.

### SUMMARY

The present application is intended to provide a temple-bending structure and smart glasses including the temple-bending structure, so as to protect a flexible printed circuit (FPC) in the smart glasses while implementing portability and easy storage.

To solve the technical problems described above, according to one aspect of the present application, a temple-bending structure is provided, including a rotating shaft structure, where one end of the rotating shaft structure is connected to a lens body, the other end of the rotating shaft structure is connected to a temple, an FPC penetrates through the rotating shaft structure from the inside of the temple and is connected to a main board inside the lens body, and the rotating shaft structure is rotated to control the temple to bend relative to the lens body; and the rotating shaft structure includes a rotating shaft housing, one end of the rotating shaft housing is fixed to the temple, the other end of the rotating shaft housing extends to the inside of the lens body, the rotating shaft housing rotates with the temple, and when the rotating shaft structure is in either stationary or rotational state, the other end of the rotating shaft housing is always located inside the lens body and always covers the FPC.

Further, the rotating shaft structure further includes a rotating shaft bracket fixedly connected to the lens body and a rotating shaft portion mounted on the rotating shaft bracket, where the rotating shaft portion includes a rotating shaft axis mounted on the rotating shaft bracket, and a first cam, a second cam, a spring, and a nut that are successively sleeved on the rotating shaft axis, when the temple is subjected to an external force, the first cam and the second cam generate a height drop, and a compression amount of the spring is changed, so that the rotating shaft portion rotates.

Further, the rotating shaft bracket includes a first axis stopping bracket and a second axis stopping bracket, where the first axis stopping bracket and the second axis stopping bracket are both L-shaped plate structures, one end of the first axis stopping bracket is fixedly connected to one end of the second axis stopping bracket, the other end of the first axis stopping bracket and the other end of the second axis stopping bracket form a mounting space, and the rotating shaft portion is mounted in the mounting space.

Further, a mounting hole is provided on the second axis stopping bracket, one end of the rotating shaft axis passes through the mounting hole, and the other end of the rotating shaft axis rotatably connects the rotating shaft axis to the first axis stopping bracket through the nut.

Further, the rotating shaft axis includes a local tapping structure.

Further, the rotating shaft housing includes a cylindrical structure, and the rotating shaft portion is located at the center of the cylindrical structure.

According to another aspect of the present application, smart glasses are provided, including the temple-bending structure.

Further, the smart glasses are AR glasses or VR glasses.

Compared with the prior art, the present application has the following significant advantages and beneficial effects: With the technical solutions described above, the temple-bending structure and the smart glasses including the temple-bending structure according to the present application can achieve considerable technical advancement and practicability, and can realize extensive values in the industry. The temple-bending structure and the smart glasses have at least the following advantages:

In the present application, the rotating shaft structure is disposed in the smart glasses, so that the temple can bend relative to the lens body, and the smart glasses are easy to fold, store and carry. In addition, the rotating shaft housing is used, so that the FPC in the smart glasses is not exposed in either state, thereby fully protecting the FPC in the smart glasses, prolonging a service life of the smart glasses, and further meeting the requirements on reliability and portability of the smart glasses.

The foregoing description is merely an overview of the technical solutions of the present application. To better understand the technical means of the present application and thus implement the technical means based on the content of the specification, and to make the foregoing and other objectives, features, and advantages of the present application clearer and more comprehensible, the following specifically describes example embodiments in detail with reference to the accompanying drawings.

### BRIEF DESCRIPTION OF DRAWINGS

FIG. 1 is a schematic diagram of a temple-bending structure according to an embodiment of the present application;

FIG. 2 is a schematic diagram of an internal structure of a temple-bending structure according to an embodiment of the present application;

FIG. 3 is a diagram of an A-A cross section of FIG. 2;

FIG. 4(a) is a schematic diagram of a natural open state of a temple-bending structure according to an embodiment of the present application;

FIG. 4(b) is a schematic diagram of a stretched-out state of a temple-bending structure according to an embodiment of the present application;

FIG. 4(c) is a schematic diagram of a folded state according to an embodiment of the present application;

FIG. 5 is a schematic diagram of a rotating shaft structure according to an embodiment of the present application; and

FIG. 6 is an exploded view of the rotating shaft structure shown in FIG. 5.

[Reference numerals]

| | |
|---|---|
| 1: lens body | 2: rotating shaft structure |
| 3: temple | 4: FPC |
| 5: rotating shaft housing | 6: first connecting portion |
| 7: second connecting portion | 21: rotating shaft bracket |
| 22: rotating shaft portion | 221: rotating shaft axis |
| 222: first cam | 223: second cam |
| 224: spring | 225: nut |
| 211: first axis stopping bracket | 212: second axis stopping bracket |

### DESCRIPTION OF EMBODIMENTS

To further describe the technical means used in the present application to achieve the intended objectives of the present application and the effects thereof, the following describes in detail the specific implementations and effects of a temple-bending structure and smart glasses including the temple-bending structure provided in the present application with reference to the accompanying drawings and example embodiments.

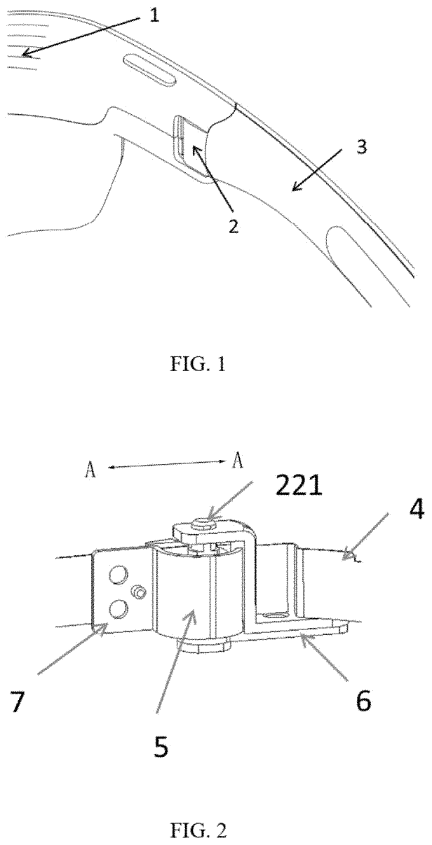

The present application provides a temple-bending structure. As shown in FIG. 1 to FIG. 3, the temple-bending structure includes a rotating shaft structure 2. One end of the rotating shaft structure 2 is connected to a lens body 1, and the other end of the rotating shaft structure 2 is connected to a temple 3. A flexible printed circuit (FPC) 4 penetrates through the rotating shaft structure 2 from the inside of the temple 3 and is connected to a main board inside the lens body 1. The rotating shaft structure 2 is rotated to control the temple 3 to bend relative to the lens body 1. The rotating shaft structure 2 includes a rotating shaft housing 5. One end of the rotating shaft housing 5 is fixed to the temple 3, and the other end of the rotating shaft housing 5 extends to the inside of the lens body 1. The rotating shaft housing rotates with the temple 3. When the rotating shaft structure 2 is in either stationary or rotational state, the other end of the rotating shaft housing 5 is always located inside the lens body 1 and always covers the FPC 4. The temple-bending structure can not only protect the FPC 4 in the smart glasses, but also make the smart glasses easy to carry and store.

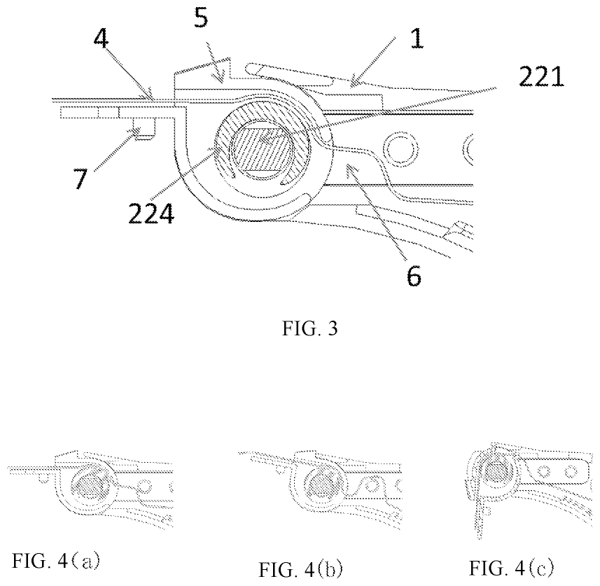

As shown in FIG. 3 and FIG. 4, an end portion of one end, of the rotating shaft structure 2, that is connected to the lens body 1 is a first connecting portion 6, and an end portion of one end, of the rotating shaft structure 2, that is connected to the temple 3 is a second connecting portion 7. FIG. 4(a) shows a natural open state of the glasses. In this state, the first connecting portion 6 and the second connecting portion 7 form a 0 degree angle. FIG. 4(b) shows a user wearing state. In this state, the first connecting portion 6 and the second connecting portion 7 stretch out. A torque is generated when the rotating shaft structure 2 stretches out, and the temple 3 is attached to the wearer's head. FIG. 4(c) is a schematic diagram of a folded state of the glasses. In this state, the temple 3 is folded. The rotating shaft housing 5 coordinates with a housing of the lens body 1 in all of the three states, so that the FPC is not exposed. FIG. 4(b) and FIG. 4(c) show two extreme states. It can be learned that, when the rotating shaft structure 2 is in either stationary or rotational state, the other end of the rotating shaft housing 5 is always located inside the lens body 1, and the rotating shaft housing 5 always coordinates with the housing of the lens body 1, so that the FPC is not exposed, thereby fully protecting the FPC 4 in the smart glasses.

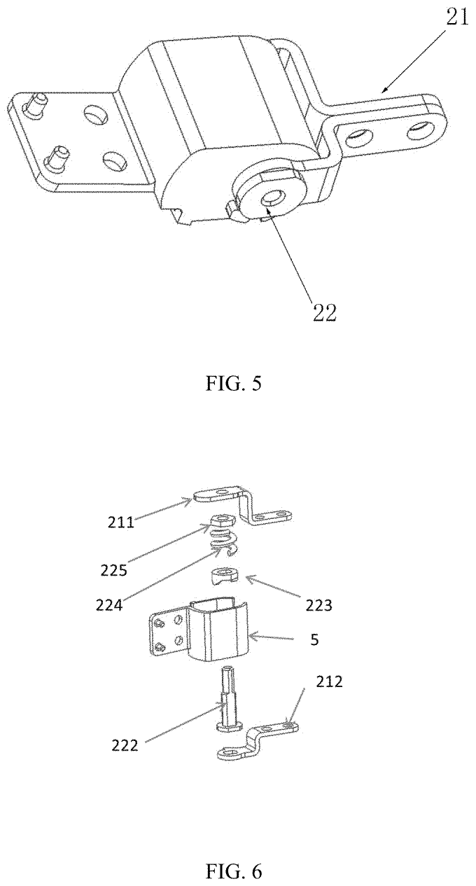

In the examples shown in FIG. 5 and FIG. 6, the rotating shaft structure 2 further includes a rotating shaft bracket 21 fixedly connected to the lens body 1 and a rotating shaft portion 22 mounted on the rotating shaft bracket 21. The rotating shaft portion 22 includes a rotating shaft axis 221 mounted on the rotating shaft bracket 21, and a first cam 222, a second cam 223, a spring 224, and a nut 225 that are successively sleeved on the rotating shaft axis 221. In a normal state, the spring 224 is in a compressed state. When the temple 3 is subjected to an external force, the first cam 222 and the second cam 223 rotate and generate a height drop, causing a compression amount of the spring 224 to increase. The second cam 223 generates an oblique torque to react against the first cam 222 and the rotating shaft housing 5, making the rotating shaft portion 22 rotate. The torque can be adjusted based on the compression amount of the spring 224 and a coordination angle between the first cam 222 and the second cam 223.

In an example shown in FIG. 6, the rotating shaft bracket 21 includes a first axis stopping bracket 211 and a second axis stopping bracket 212. The first axis stopping bracket 211 and the second axis stopping bracket 212 are both L-shaped plate structures, one end of the first axis stopping bracket 211 is fixedly connected to one end of the second axis stopping bracket 212, the other end of the first axis stopping bracket 211 and the other end of the second axis stopping bracket 212 form a mounting space, and the rotating shaft portion 22 is mounted in the mounting space. As an example, a mounting hole is provided on the second axis stopping bracket 212, and one end of the rotating shaft axis 221 passes through the mounting hole. The rotating shaft axis 221 includes a local tapping structure, and the bottom of the rotating shaft axis 221 is locked with a screw to a glasses end to reinforce the strength and cancel the lever stress. The other end of the rotating shaft axis 221 rotatably connects the rotating shaft axis 221 to the first axis stopping bracket through the nut 225. The first axis stopping bracket 211 and the second axis stopping bracket 212 coordinate with each other to reinforce the stopping and fixing of the rotating shaft axis 221 and prevent a torque and an intercept caused by bending the rotating shaft from damaging the rotating shaft.

As an example, the rotating shaft housing 5 includes a cylindrical structure, and the rotating shaft portion 22 is located at the center of the cylindrical structure. However, it can be understood that, the rotating shaft housing 5 is not limited to the cylindrical structure, and other shape designs are applicable to the present application, provided that in the shape designs, the other end of the rotating shaft housing 5 is always located inside the lens body 1 when the rotating shaft structure 2 is in either stationary or rotational state.

An embodiment of the present application further provides smart glasses, including the temple-bending structure described in the embodiment of the present application. The smart glasses are AR glasses, VR glasses, or the like.

According to the temple-bending structure and the smart glasses including the temple-bending structure in the present application, the rotating shaft structure 2 is disposed in the smart glasses, so that the temple 3 can bend relative to the lens body 1, and the smart glasses are easy to fold, store, and carry. In addition, the rotating shaft housing 5 is used, so that the FPC 4 in the smart glasses is not exposed in either state, thereby fully protecting the FPC 4 in the smart glasses, prolonging a service life of the smart glasses, and further meeting requirements on reliability and portability of the smart glasses.

The foregoing descriptions are merely example embodiments of the present application, and are not intended to limit the present application in either form. Although the present application has been disclosed in the example embodiments above, the example embodiments are not intended to limit the present application. Without departing from the scope of the technical solutions of the present application, any person skilled in the art can use the technical content disclosed above to make some changes or improvements to produce equivalent embodiments with equivalent changes. Any modification, equivalent change, or improvement made based on the technical nature of the present application without departing from the content of the technical solutions of the present application shall fall within the protection scope of the technical solutions of the present application.

1. A temple-bending structure, comprising a rotating shaft structure, wherein one end of the rotating shaft structure is connected to a lens body, the other end of the rotating shaft structure is connected to a temple, a flexible printed circuit (FPC) penetrates through the rotating shaft structure from the inside of the temple and is connected to a main board inside the lens body, and the rotating shaft structure is rotated to control the temple to bend relative to the lens body; and
the rotating shaft structure comprises a rotating shaft housing, one end of the rotating shaft housing is fixed to the temple, the other end of the rotating shaft housing extends to the inside of the lens body, the rotating shaft housing rotates with the temple, and when the rotating shaft structure is in either stationary or rotational state, the other end of the rotating shaft housing is always located inside the lens body and always covers the FPC.

2. The temple-bending structure according to claim 1, wherein
the rotating shaft structure further comprises a rotating shaft bracket fixedly connected to the lens body and a rotating shaft portion mounted on the rotating shaft bracket, wherein the rotating shaft portion comprises a rotating shaft axis mounted on the rotating shaft bracket, and a first cam, a second cam, a spring, and a nut that are successively sleeved on the rotating shaft axis, when the temple is subjected to an external force, the first cam and the second cam generate a height drop, and a compression amount of the spring is changed, so that the rotating shaft portion rotates.

3. The temple-bending structure according to claim 2, wherein
the rotating shaft bracket comprises a first axis stopping bracket and a second axis stopping bracket, wherein
the first axis stopping bracket and the second axis stopping bracket are both L-shaped plate structures, one end of the first axis stopping bracket is fixedly connected to one end of the second axis stopping bracket, the other end of the first axis stopping bracket and the other end of the second axis stopping bracket form a mounting space, and the rotating shaft portion is mounted in the mounting space.

4. The temple-bending structure according to claim 3, wherein
a mounting hole is provided on the second axis stopping bracket, one end of the rotating shaft axis passes through the mounting hole, and the other end of the rotating shaft axis rotatably connects the rotating shaft axis to the first axis stopping bracket through the nut.

5. The temple-bending structure according to claim 2, wherein the rotating shaft axis comprises a local tapping structure.

6. The temple-bending structure according to claim 1, wherein the rotating shaft housing comprises a cylindrical structure, and the rotating shaft portion is located at the center of the cylindrical structure.

7.-8. (canceled)
